(19) United States
(12) Patent Application Publication
(10) Pub. No.: US 2014/0164650 A1
(43) Pub. Date: Jun. 12, 2014

(54) System, method and computer program product for monitoring and alerting the health of sub-system connectors

(71) Applicant: DELL PRODUCTS L.P., Round Rock, TX (US)

(72) Inventors: Bryan James Thornley, Burnet, TX (US); Claude Lano Cox, Austin, TX (US); Nikhil Manohar Vichare, Austin, TX (US); Vinod Makhija, Austin, TX (US)

(73) Assignee: Dell Products L.P., Round Rock, TX (US)

(21) Appl. No.: 13/708,826

(22) Filed: Dec. 7, 2012

(51) Int. Cl. G06F 11/30

(52) U.S. Cl. CPC G06F 11/3093
USPC 710/19

(57) ABSTRACT

An information handling system that monitors and tracks the connectivity status of physical sub-system connectors in the field while the system is in a user-operational mode and provides alerts when connectivity problems are detected.

### FIELD OF THE INVENTION

The present disclosure relates generally to information handling systems, and more particularly to an information handling system which monitors the connectivity status of physical sub-system connectors and provides alerts when connectivity problems are detected.

### BACKGROUND

In conventional computer systems, a faulty touchpad, keyboard or speaker connection can become quite frustrating and costly for the end user. If, for example, a connection in the system is broken, a technician may have to dis-assemble the system or use tools that cannot execute on the operating system. As such, the system must be taken off-line whereby the user no longer has operational access, which results in increased down time at the service desk and loss of productivity. In addition, if the connection issues are intermittent, the diagnosis may be a “no trouble found” or “could not duplicate” situation that further increases the total service costs and loss of productivity. Furthermore, conventional systems provide no solution to track the status and status changes of the connectors over the life of the system.

Accordingly, there is a need in the art for a computer system which monitors the connectivity status of system connectors while the system remains in a user-operational mode.

### SUMMARY

Exemplary embodiments and methodologies of the present invention provide an information handling system (“IHS”) that monitors and tracks the connectivity statuses of its sub-system connectors. The connectivity status of the connectors are monitored and tracked in the field while the IHS remains in a user-operational mode. As the IHS monitors, tracks and/or probes the connectivity statuses, intermittent or continuous disconnections may be detected. If so, the IHS may log this data to track connectivity issues over a period of time. In addition, an alert signal may be transmitted to the end-user or some remote location for trouble-shooting or other technical analysis. The IHS may be probed on-demand or at some other desired time point to determine the connectivity statuses. Accordingly, trouble shooting of connectors may be performed without unnecessary downtime.

### BRIEF DESCRIPTION OF THE DRAWINGS

FIG. 1A illustrates the architecture of an information handling system according to an exemplary embodiment of the present invention;

FIG. 1B illustrates the architecture of a connectivity probing module residing on an information handling system according to an exemplary embodiment of the present invention;

FIG. 1C is a table showing bitmap bit definitions for exemplary sub-systems within an information handling system according to an exemplary embodiment of the present invention;

FIG. 2 illustrates a network architecture to provide connectivity alerts over a local network according to an exemplary embodiment of the present invention;

FIG. 3 illustrates a network architecture to provide connectivity alerts in a System Center Configuration Manager environment; and

FIG. 4 is a flow chart of a methodology to monitor one or more physical sub-system connectors of an information handling system according to an exemplary methodology of the present invention.

### DETAILED DESCRIPTION

Illustrative embodiments and related methodologies of the present invention are described below as they might be employed in a system to monitor the connectivity status of physical sub-system connectors. In the interest of clarity, not all features of an actual implementation or methodology are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

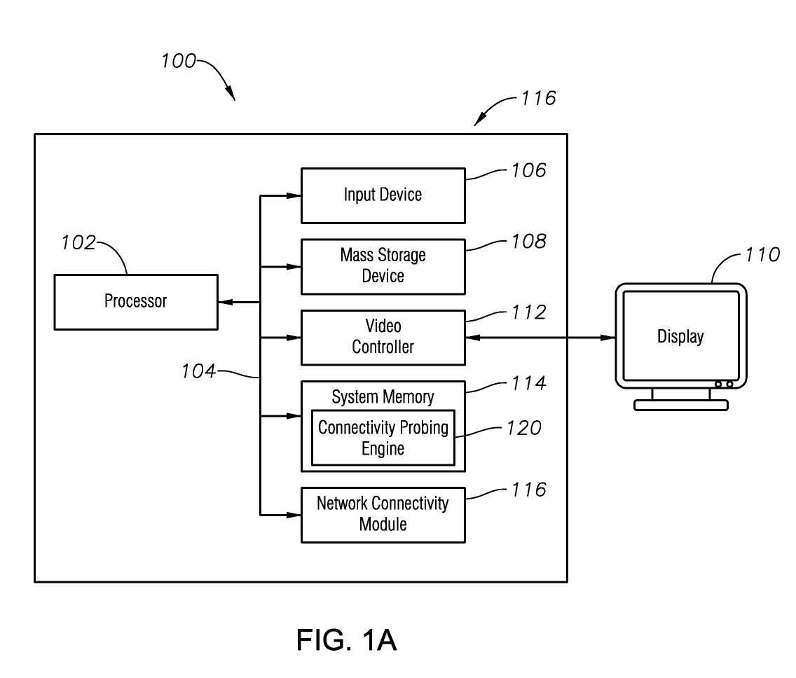

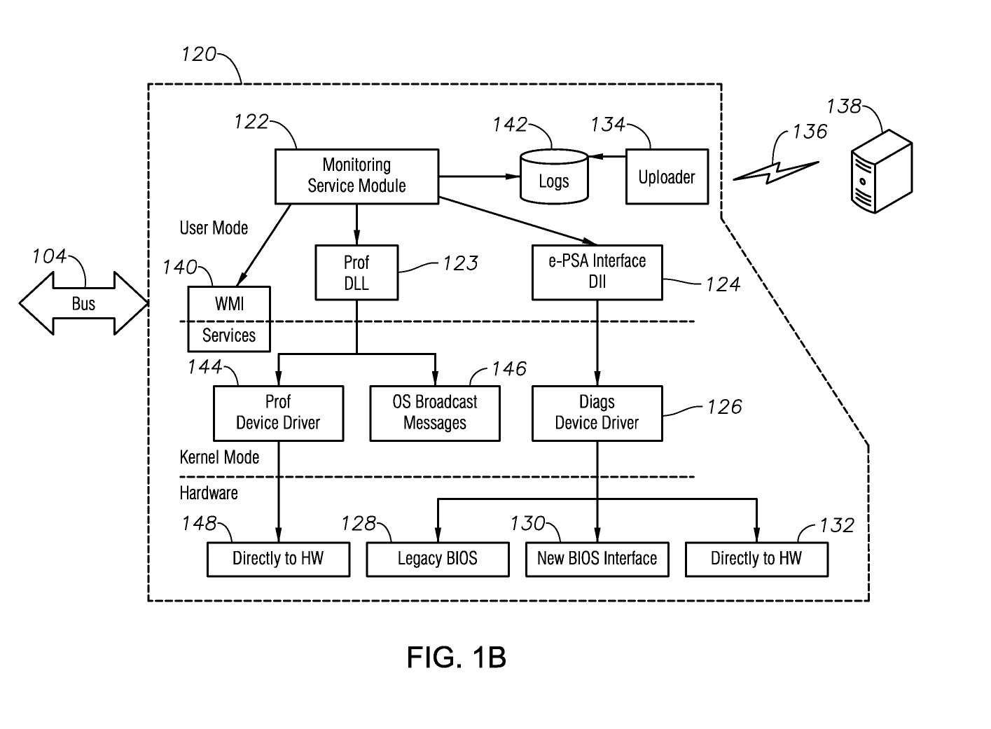

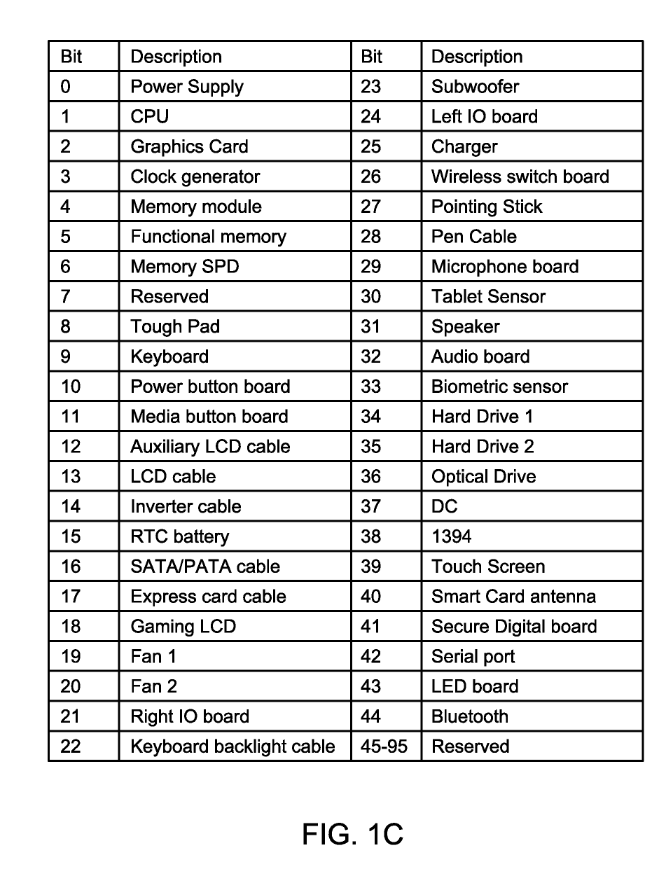

FIG. 1A illustrates the system architecture of an information handling system (“IHS”) 100 for monitoring the connectivity statuses of sub-system connectors according to an exemplary embodiment of the present invention. As will be described herein, exemplary embodiments of IHS 100 monitor the connectivity status of its sub-system components in the field while IHS 100 remains in a user-operational mode. User-operational mode, as understood in the art, refers to the non-privileged execution mode wherein the user still has access to the normal system operating conditions (windows, etc.). As IHS 100 monitors and/or probes the connectivity statuses, intermittent or continuous disconnections may be detected. If so, IHS 100 may log this data to track connectivity issues over a period of time. In addition, certain exemplary embodiments may transmit an alert signal to the end-user or some remote location, for example, for trouble-shooting or other technical analysis. In the alternative, IHS 100 may be probed on-demand to determine the connectivity statuses. Accordingly, trouble shooting of connectors may be performed without unnecessary downtime.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

Referring to the exemplary embodiment of FIG. 1A, IHS 100 includes a processor 102 that is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data may be stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112.

A system memory 114 is also coupled to processor 102 to provide the processor with fast storage to facilitate execution of computer programs by processor 102. Examples of system memory may include, for example, random access memory (“RAM”) devices such as dynamic RAM (“DRAM”), synchronous DRAM (“SDRAM”), solid state memory devices, and/or a variety of other memory devices known in the art. A network communication module 118 is further coupled to processor 102 to communicate with one or more public and/or private networks via one or more wired or wireless protocols. In certain exemplary embodiments, a chassis 116 houses some or all of the components of IHS 100. Those ordinarily skilled in the art having the benefit of this disclosure will understand that other buses and intermediate circuits can be deployed between the components described above and processor 102 to facilitate interconnection between the components and the processor 102.

Still referring to the exemplary embodiment shown in FIG. 1A, a connectivity probing engine 120 resides on system memory 114. As described herein, connectivity probing engine 120 comprises software instructions executable by the processor 102 for implementing exemplary embodiments of the present invention. In the alternative, the software instructions embodied in connectivity probing engine 120 may also be stored on a computer-readable medium.

FIG. 1B illustrates a detailed architecture of an exemplary connectivity probing engine 120. Connectivity probing engine 120 comprises a monitoring service module 122 that probes and tracks the connectivity status of physical sub-system connectors residing within IHS 100. As described herein, the operations of monitoring service module 122 are invisible to the end-user, and may be conducted on demand or at predetermined intervals that are preconfigured. In addition, certain exemplary embodiments may conduct the probing in conjunction with a system event such as, for example, a resume from sleep mode, reboot, etc. The connectivity status data may then be stored in a database log 142 to track changes over time for providing diagnosis of intermittent connection failures, thereby avoiding “could not duplicate” or “no fault found” diagnoses. The connectivity statuses may be output from log 142 on a desired basis. In addition, the operations of monitoring service module 122 may be executed on-demand from a remote location such as, for example, by a service technician on the phone or at a repair depot. Once the connectivity tests are complete, connectivity probing engine 120 will transmit a read-out reflecting the health status of desired connections located on the IHS.

An exemplary monitoring service platform embodied within monitoring service module 122 may be, for example, the Dell® Client System Analyzer™ (“DCSA”) or Dell® Data Vault™ (“DDV”), commercially available through the Assignee of the present invention, Dell Products L.P. of Round Rock, Tex. However, those ordinarily skilled in the art having the benefit of this disclosure realize other monitoring platforms may be utilized. Through utilization of monitoring service module 122, connectivity probing engine 120 probes the status of connections from all devices supported on IHS 100 to obtain information about the connectivity status of device connections such as, for example, a keyboard, touchpad, fan, pointer stick, microphone or other sub-systems listed in FIG. 1C. Processor 102 then passes this connectivity status data to the operating system (Windows® OS, for example), where it is consumed by monitoring service module 122 and transmitted as alert signal to an end user or remote location via display 110 or network communication module 118.

To achieve the foregoing objectives, an exemplary embodiment of connectivity probing engine 120 utilizes a dynamic link library (“DLL”) 123 and DLL interface 124 at the user mode level to interface with a diagnostic device driver 126 in order to obtain connectivity and other data from multiple sources such as, for example, legacy BIOS-Test interface 128, BIOS-Test interface 130 or directly from hardware 132 at the hardware level. An exemplary dynamic link library may be, for example, an Enhanced Pre-Boot System Assessment (“ePSA”) library, as would be understood by those ordinarily skilled in the art having the benefit of this disclosure. An exemplary BIOS-Test interface 130 may be, for example, a Dell® Platform Advanced Integrated Diagnostics interface (“PAID”), which is a BIOS interface for ePSA.

BIOS-Test interface 130 provides the connectivity status of physical sub-system connectors in IHS 100 while the system remains in user-operational mode. In certain exemplary embodiments, BIOS-Test interface 130 is comprised of pre-POST tests, PSA initiated tests and PSA diagnostic feature queries. Using BIOS-Test interface 130, at any time, connectivity probing engine 120 may request the connectivity status of all supported devices in IHS 100. Once requested, BIOS-Test interface 130 analyzes and decodes the circuit board signal lines corresponding to each sub-system connector to determine if they are connected or disconnected. The resulting connectivity data is then reported to diagnostic device driver 126 in a bit-mapped fashion where each bit will reflect the status of the corresponding device connector. FIG. 1C is a table showing exemplary PAID Tests bitmap bit definitions for exemplary sub-systems within IHS 100. Then, DLL interface 124 passes the connectivity data on to monitoring service module 122, where it is transmitted accordingly.

Therefore, through utilization of a PAID test result bitmap, connectivity probing engine 120 may retrieve and transmit the connectivity data on-demand in real-time or, in the alternative, on a defined intermittent basis. Once connectivity probing engine 120 initiates a probe of IHS 100, BIOS-Test interface 130 will return a fully populated bitmap upon completion of all tests. However, results for some of the tests (such as, for example, power button, keyboard and media board detects) may be acquired only once at power up and, thereafter, be reported to BIOS-Test interface 130 from memory locations without actually querying the hardware at the time of the probing request.

In certain exemplary embodiments, a variety of functions may be utilized by BIOS-Test interface 130. For example, a “Get PAID Tests Results bitmap” function may be invoked to acquire the status of a PAID test (pass/fail). Once this function is executed, each test will be performed by BIOS-Test interface 130 and the results returned in bitmap fashion. Thereafter, a “Get PAID Tests Blocked bitmap” function may be utilized to determine if corresponding PAID tests are blocked. When this function is called, a full bitmap of block tests may be return. A “Get PAID Tests Supported bitmap” function may also be used to determine if a corresponding PAID test is supported on the system platform. Also, a “Get PAID Tests Results History bitmap” function may also be utilized to determine which supported tests have failed since the BIOS logs have been reset/cleared, or since the IHS has been assembled. The corresponding bit may be set if a given test has ever been reported as failed in “PAID Test results” bitmap while being supported and not blocked. In addition, a “Get PAID Features Supported bitmap” function may be utilized to determine which PAID reporting features are supported. A “Get PAID Features Status bitmap” may be utilized to determine the status of additional PAID reporting features. These and a variety of other functions will be readily apparent to those ordinarily skilled in the art having the benefit of this disclosure.

Still referring to FIG. 1B, this exemplary embodiment of monitoring service module 122 runs as a Windows® Service and senses hardware parameters in real time to provide a daily summary of hardware use, performance, and select inventory parameters. Connectivity probing engine 120 further comprises an uploader 134 having a configurable phone-home feature to communicate over network 136 (Internet, Cloud, for example), via network communication module 118, with a backend database, analytics, and reporting server 138. As a result, connectivity statuses of sub-system connectors may be transmitted to server 138 on a periodic or continuous basis. Thus, in certain exemplary embodiments, IHS 100 may provide business intelligence for IT on system-health management and various aspects of asset use and performance.

Monitoring service module 122 also interfaces with Windows Management Instrumentation (“WMI”) services infrastructure 140 at the user mode level. In certain exemplary embodiments of the present invention used in managed IT environments, the change of state, or a disconnection, can be formatted in a DDV WMI namespace and exposed to an IT administrator via an enterprise management console. To implement such embodiments, monitoring service module 122 formats parametric based data and events in a WMI namespace. As understood in the art, WMI is the infrastructure for management of data and operations on Windows® based operating systems, and represents Microsoft's® implementation of Web Based Enterprise Management (“WBEM”), which is an industry standard technology for accessing management data across the enterprise. WMI uses the Common Information Model (“CIM”) industry standard to represent systems, applications, networks, devices, and other managed components. Through utilization of WMI services infrastructure 140, IHS 100 may be remotely probed via Distributed Component Object Model, for example, as would be understood by those ordinarily skilled in the art having the benefit of this disclosure.

Still referring to the exemplary architecture of FIG. 1B, DLL 123 communicates with device driver 144 and operating system broadcast messages 146 at the kernel mode level, as understood in the art. Monitoring service module 122 utilizes device driver 144 to obtain direct access to registers at the hardware level that are not available via the standard operating system application programming interface (“API”).

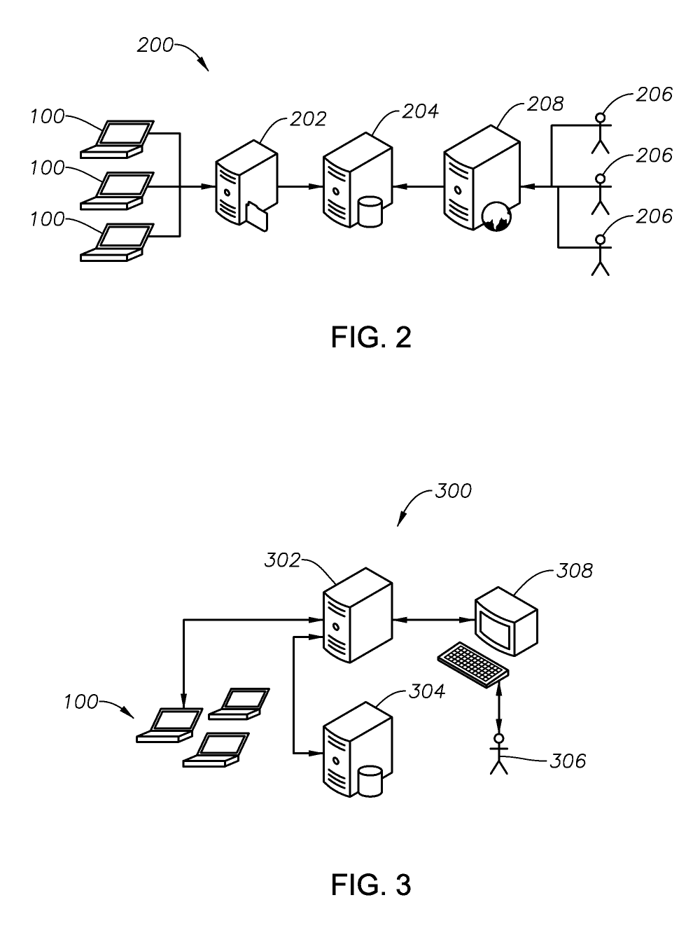

FIG. 2 illustrates an exemplary network architecture 200 that provide connectivity alerts to service personnel when IHS 100 is hosted on a local network. As previously described, monitoring service module 122 may also utilize DDV to probe and track the connectivity status of physical sub-system connectors residing within IHSs 100. In this exemplary embodiment, monitoring service engine 120 residing on IHSs 100 enables easy access to DCSA based parametric data and events by management applications interacting with the WMI services infrastructure 140 on endpoints across the enterprise. To achieve this, enterprise endpoint data related to physical sub-system connectivity of IHSs 100 will be collected as previously described and transmitted to a file collection server 202. The connectivity data is then communicated to a DDV database 204, such as, for example, an SQL server, where it is formatted and stored until an end-user 206, such as, for example, an IT administrator, initiates an on-demand probe. Here, end-user 206 may utilize a web-based alerting and reporting tool 208 to access the connectivity data of IHSs 100.

FIG. 3 illustrates yet another exemplary network architecture 300 to provide connectivity status alerts in a System Center Configuration Manager (“SCCM”) environment. As previously described, monitoring service engine 120 (residing on IHSs 100) collects the connectivity status data of physical connectors residing on IHSs 100 and transmits the data to SCCM server 302. The connectivity data is then communicated to an SCCM persistent database 304, such as, for example, an SQL server, where it is formatted and stored. An end-user 306, such as, for example, an IT administrator, may then initiate an on-demand probe utilizing a web-based alerting and reporting console 208 to access the connectivity data of IHSs 100. Moreover, in this exemplary embodiment, the connectivity data is formatted and presented to end-user 306 using an SQL service reporting script, as will be understood by those ordinarily skilled in the art having the benefit of this disclosure.

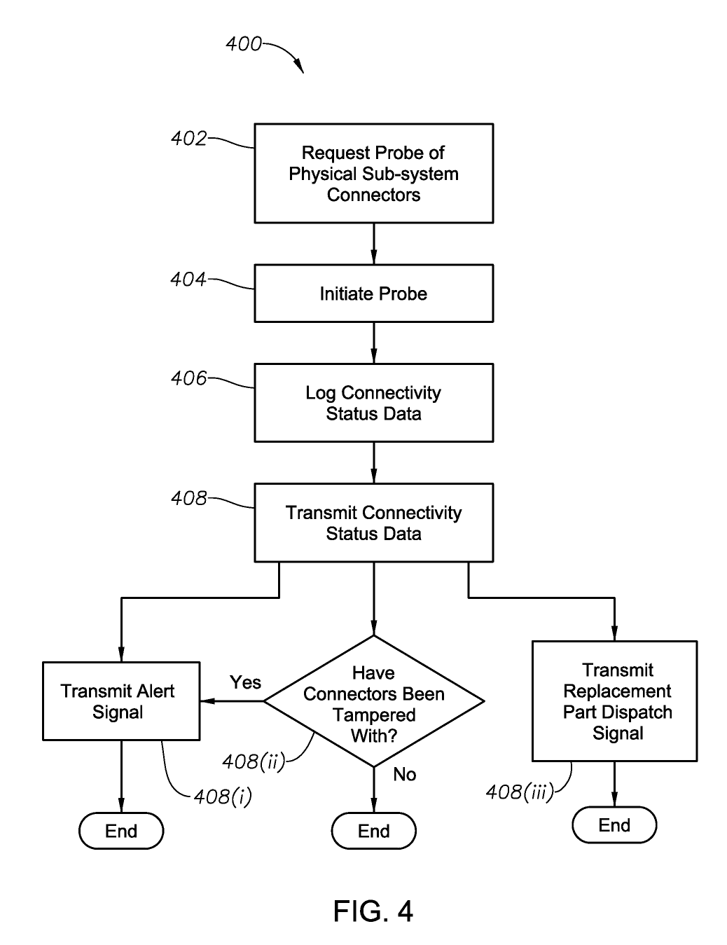

Accordingly, FIG. 4 illustrates a methodology 400 to monitor one or more physical sub-system connectors of an IHS 100 according to an exemplary methodology of the present invention. As previously described, the exemplary methodologies described herein are conducted while IHS 100 is in a user-operational mode. At block 402, IHS 100, via processor 102, requests a probe of the connectivity status of one or more physical sub-system connectors residing on IHS 100. In the alternative, the probing request may be initiated by a remote endpoint. Nevertheless, in either embodiment, the probing may be initiated at a predetermined interval or on-demand via a local or remote user interface, or in conjunction with a system event such as, for example, a resume from sleep mode, reboot, etc. At block 404, processor 102, via connectivity probing engine 120, then initiates the probe where, utilizing the exemplary architecture shown in FIG. 1B, the connectivity statuses of the physical sub-system connectors are analyzed to determine whether the connectors are connected or continuously disconnected.

At block 406, IHS 100 may then log the connectivity status data in log 142, whereby the logged data may be retrieved and/or analyzed at a later data to determine intermittent connectivity problems. At block 408, IHS 100 may then transmit the connectivity status data to a remote or local user interface. At block 408(i), in certain exemplary embodiments, IHS 100 may also transmit an alert signal to the local or remote user interface if the connectivity data reflects a continuous or intermittent disconnect state. In another embodiment, when an intermittent or continuous disconnection is detected, IHS 100 may also transmit a signal to dispatch a replacement part for IHS 100 to remedy the connectivity issue at block 408(iii). Furthermore, at block 408(ii) IHS 100 may also compare the connectivity status data of IHS 100 with its original shipping data (which may be logged in a database as described herein) to determine whether IHS 100 has been altered or otherwise tampered with since shipping. If IHS 100 determines tampering/disconnection has occurred, an alert signal may then be transmitted accordingly at block 408(i). However, if IHS 100 determines that no tampering has occurred, the process ends. Accordingly, the connectivity issues may be troubleshot while IHS 100 is in a user-operational mode, thus avoiding any unnecessary downtime.

Exemplary embodiments of the present invention may be utilized in a variety of ways. For example, connectivity probing engine 120 may continuously monitor IHS 100 and transmit an automatic alert signal to a desired endpoint such as, for example, an end-user or IT administration station, once a disconnection of a physical sub-system connector is detected. In another embodiment that may be utilized by large enterprise customers using IT management tools (MS SCCM, Altiris, etc.), the change of state (i.e., disconnection) can be formatted in a WMI namespace and then exposed to the IT administrator as part of an inventory update on a particular IHS 100. In yet another embodiment utilized by IT customers running a managed client server solution of the monitoring service module 122, the change of state can be processed as an alerting condition and stored in a database. Such alerting conditions may also be correlated to logistics applications for auto-dispatch of parts.

In another exemplary embodiment, in the event that an IHS is returned to a repair depot, connectivity probing engine 120 may be installed in the IHS, and an analysis of the connectivity status is then conducted as described herein. Such connectivity status data may then be compared with an “as-shipped” database to detect alterations from the original shipping configuration of the IHS. In other embodiments, the logged connectivity data described herein may related to the “as shipped,” “after transportation,” “periodically in use,” or “last known good use state” conditions of the IHS. In such embodiments, the connectivity status of the IHS may be compared to logged connectivity data to determine if the system connectors have been disconnected/altered, and appropriate action taken accordingly.

Moreover, in yet another exemplary embodiment, when an end-user calls-in for technical support, connectivity probing engine 120 can then be installed on the end-user IHS and run from a remote server to perform a connectivity analysis of the sub-system connectors. In yet another embodiment, the methodologies described herein may be utilized to determine if a warranty of an IHS was violated by an end-user by tracking chassis intrusions and disconnected connectors. These and other applications of the present invention will be readily understood by those ordinarily skilled in the art having the benefit of this disclosure.

The exemplary embodiments disclosed herein provide a number of advantages. For example, the present invention enables real time assessment of system health in the field, increases end-user productivity, reduces down time, improves customer experience and reduces test and diagnosis times for service technicians. In addition, the present invention assists in more efficient boot part dispatch metrics such as, for example, system diagnosis, appropriate part dispatch and failure analysis. Moreover, the present invention may be integrated into auto service ticket generation and automatic part dispatch processes.

An exemplary methodology of the present invention provides a computer-implemented method to monitor one or more physical sub-system connectors of a IHS, the method comprising probing a connectivity status of the one or more physical sub-system connectors of the IHS while the IHS is in a user-operational mode. Another method further comprises logging the connectivity status of the one or more physical sub-system connectors. Yet another further comprises transmitting the connectivity status of the one or more physical sub-system connectors. In another, probing the connectivity status further comprises determining whether the one or more physical sub-system connectors has a continuous disconnection or an intermittent disconnection. In yet another, transmitting the connectivity status further comprises transmitting an alert signal if the one or more physical sub-system connectors has a continuous disconnection or intermittent disconnection.

In yet another methodology, probing the connectivity status is performed at a pre-determined interval, on-demand, upon a resume from sleep mode, or upon a reboot of the IHS. Another methodology further comprises at least one of transmitting a signal to dispatch an IHS part when a continuous or intermittent disconnection is detected or comparing the connectivity status of the IHS with logged connectivity data of the IHS to determine whether the IHS has been altered in comparison to the logged connectivity data.

Furthermore, the exemplary methodologies described herein may be implemented by a system comprising processing circuitry or a computer program product comprising instructions which, when executed by at least one processor, causes the processor to perform any of the methodology described herein.

Although various embodiments and methodologies have been shown and described, the invention is not limited to such embodiments and methodologies and will be understood to include all modifications and variations as would be apparent to one ordinarily skilled in the art. For example, in some instances, some features of the embodiments may be employed without a corresponding use of other features. Therefore, it should be understood that the invention is not intended to be limited to the particular forms disclosed. Rather, the intention is to cover all modifications, equivalents and alternatives falling within the spirit and scope of the invention as defined by the appended claims.

1. A subsystem connector monitoring system, comprising:
a chassis housing a computing system;
a physical subsystem connector that is included within the chassis and that is coupled to the computing system;
a subsystem device that is included within the chassis and that is configured to connect to the computing system through the physical subsystem connector; and
a connectivity probing engine that is included within the chassis and that is configured to:
determine a connectivity status of the physical subsystem connector with the subsystem device while the computing system is in a user-operational mode.

2. The subsystem connector monitoring system of claim 1, wherein the connectivity probing engine is further configured to:
log the connectivity status of the physical subsystem connector with the subsystem device.

3. The subsystem connector monitoring system of claim 1, wherein the connectivity probing engine is further configured to:
transmit the connectivity status of the physical subsystem connector with the subsystem device to a network that is connected to the computing system and that is external to the chassis.

4. The subsystem connector monitoring system of claim 1, wherein the determining the connectivity status further comprises:
determining whether the physical subsystem connector has a continuous disconnection or an intermittent disconnection with the subsystem device.

5. The subsystem connector monitoring system of claim 4, wherein the transmitting the connectivity status further comprises:
transmitting an alert signal in response to determining that the physical subsystem connector has the continuous disconnection or the intermittent disconnection with the subsystem device.

6. The subsystem connector monitoring system of claim 1, wherein the determining the connectivity status is performed:
at a pre-determined interval;
on-demand;
upon a resume from a sleep mode; or
upon a reboot operation.

7. The subsystem connector monitoring system of claim 1, wherein the connectivity probing engine is further configured to:
compare the connectivity status of the physical sub-system connector with logged connectivity data to determine whether the computing system has been altered in comparison to the logged connectivity data.

8. An information handling system (“IHS”), comprising:
a processing system that is housed within the IHS chassis and that is coupled to a physical IHS subsystem connector that is housed within the IHS chassis;
a memory system that is housed within the IHS chassis and that includes instructions that, when executed by the processing system, cause the processing system to provide a connectivity probing engine that is configured to:
determine a connectivity status of the physical IHS subsystem connector with an IHS subsystem that is housed within the IHS chassis, wherein the determining is performed during an IHS user-operational mode in which an operating system is available for use by a user.

9. The IHS of claim 8, wherein the connectivity probing engine is further configured to:
log the connectivity status of the physical IHS subsystem connector with the IHS subsystem.

10. The IHS of claim 8, wherein the connectivity probing engine is further configured to:
transmit the connectivity status of the physical IHS subsystem connector with the IHS subsystem to a network that is connected to the processing system and that is external to the IHS chassis.

11. The IHS of claim 8, wherein determining the connectivity status further comprises:
determining whether the physical IHS subsystem connector has a continuous disconnection or an intermittent disconnection with the IHS subsystem.

12. The IHS of claim 11, wherein the transmitting the connectivity status further comprises:
transmitting an alert signal in response to determining that the physical IHS subsystem connectors has the continuous disconnection or the intermittent disconnection with the IHS subsystem.

13. The IHS of claim 8, wherein the determining the connectivity status is performed:
at a pre-determined interval;
on-demand;
upon a resume from a sleep mode; or
upon a reboot operation.

14. The IHS of claim 8, wherein the connectivity probing engine is further configured to:
compare the connectivity status of the physical IHS subsystem connector with logged connectivity data to determine whether the IHS chassis has been tampered with.

15. A method for monitoring physical subsystem connectors that are located within an information handling system (“IHS”), comprising:
providing an IHS chassis that houses each of a processing system, an IHS subsystem, a physical subsystem connector, and a connectivity probing engine; and
determining, using the connectivity providing engine, a connectivity status of the physical subsystem connector with the IHS subsystem while the processing system provides a user-operational mode in which an operating system is available for use by a user.

16. The method of claim 15, further comprising:
logging the connectivity status of the physical subsystem connectors with the IHS subsystem.

17. The method of claim 15, further comprising:
transmitting the connectivity status of the physical subsystem connector with the IHS subsystem.

18. The method of claim 15, wherein determining the connectivity status further comprises:
determining whether the physical subsystem connector has a continuous disconnection or an intermittent disconnection with the IHS subsystem; and
transmitting an alert signal in response to determining the physical subsystem connector has the continuous disconnection or the intermittent disconnection with the IHS subsystem over a network that is connected to the processing system and that is external to the IHS chassis.

19. The method of claim 15, wherein determining the connectivity status is performed:
at a pre-determined internal;
on-demand;
upon a resume from a sleep mode; or
upon a reboot operation.

20. The method of claim 18, further comprising:
comparing the connectivity status of the physical subsystem connector with logged connectivity data to determine whether the IHS chassis has been tampered with.
